(19) United States
(12) Patent Application Publication
(10) Pub. No.: US 2012/0036320 A1
(43) Pub. Date: Feb. 9, 2012

(54) SYSTEM AND METHOD FOR PERFORMING A CONSISTENCY CHECK OPERATION ON A DEGRADED RAID 1E DISK ARRAY

(76) Inventor: NAVEEN KRISHNAMURTHY, Bangalore (IN)

(21) Appl. No.: 12/851,571

(22) Filed: Aug. 6, 2010

(51) Int. Cl. G06F 12/00

(52) U.S. Cl. 711/114; 711/E12.001

(57) ABSTRACT

A system and method for performing a consistency check operation on a degraded RAID 1E disk array is disclosed. In one embodiment, in a method for performing a consistency check on a degraded RAID 1E disk array, a read request is sent to a first row in all mirror sets having no missing disks. Then, an exclusive—OR (XOR) operation is performed on the first row in all the mirror sets having no missing disks for determining data consistency between a pair of disks in the mirror set. Further, data on a mirrored disk in all the mirror sets having no missing disks is updated based on the outcome of the performed XOR operation.

### BACKGROUND

Consistency check (CC) is a mechanism or operation used in a redundant array of independent disks (RAID) firmware to verify whether all rows in a disk array associated with a redundant RAID level are consistent. In RAID 1, the data is mirrored when an inconsistent row is detected during a CC operation. In RAID 5 and RAID 6, parity data is recreated from peer drives during the CC operation. The CC operation may also include variant implementations and secondary RAID levels based on RAID 1, RAID 5 and RAID 6 and RAID 10, RAID 50, RAID 60.

Typically, two basic functions are performed during a CC cycle. The first one includes reading data from a disk array and the second one includes performing XOR operation on the read data to validate consistency. To read the data from the disk array, the CC operation sends read requests to all disks forming the disk array. RAID 1E disk array (also known as PRL 11) has been implemented in the RAID firmware as an extension of RAID 1 disk array. RAID 1E disk array can be considered as a collection of multiple RAID 1 disk arrays, where each RAID 1 disk array in the RAID 1E disk array is referred to as a mirror set. During a CC operation on the RAID 1E disk array, read requests are sent simultaneously to all the RAID 1 disk arrays, i.e., to all mirror sets or physical arms. Then, an XOR operation is performed on each mirror set to check whether the data is consistent with parity/mirror. However, existing CC operation do not support performing the CC operation on a degraded RAID 1E disk array. Typically, in the RAID 1E disk array, any drive failure in any mirror set results in placing the RAID 1E disk array in a degraded state.

### BRIEF DESCRIPTION OF THE DRAWINGS

Various embodiments are described herein with reference to the drawings, wherein:

FIG. 1 illustrates a computer implemented flow diagram of an exemplary method for performing a consistency check (CC) operation on a degraded redundant array of independent disks (RAID) 1E disk array, according to one embodiment;

FIG. 2A illustrates an exemplary degraded spanned RAID 1E disk array including 8 mirror sets created using 16 disks, according to one embodiment;

FIG. 2B illustrates an exemplary degraded non-spanned RAID 1E disk array including 4 mirror sets created using 8 disks, according to one embodiment; and

FIG. 3 illustrates an exemplary storage system for implementing embodiments of the present subject matter.

The drawings described herein are for illustration purposes only and are not intended to limit the scope of the present disclosure in any way.

### DETAILED DESCRIPTION

A system and method for performing a consistency check operation on a degraded RAID 1E disk array is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

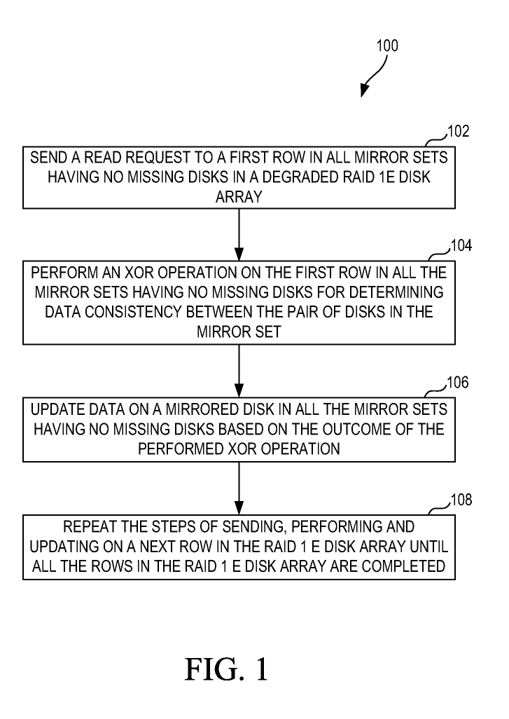

FIG. 1 illustrates a computer implemented flow diagram of an exemplary method 100 for performing a consistency check (CC) operation on a degraded redundant array of independent disks (RAID) 1E disk array, according to one embodiment. The RAID 1E disk array is an extension of RAID 1 disk array and includes multiple RAID 1 disk arrays, where each RAID 1 disk array forms a mirror set. Thus, the degraded RAID 1E disk array includes a plurality of mirror sets which are independent of each other.

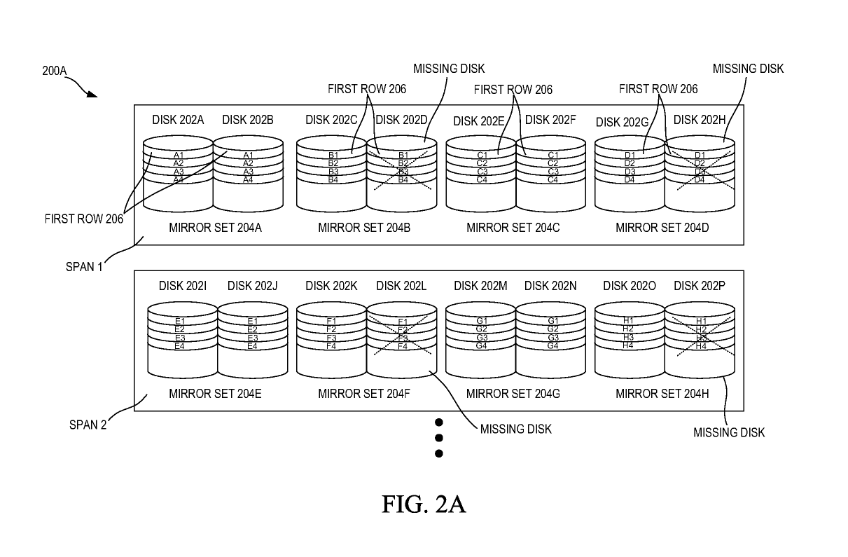

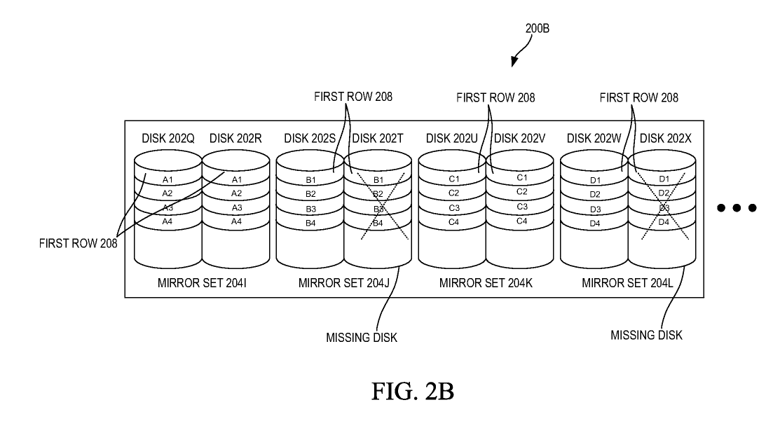

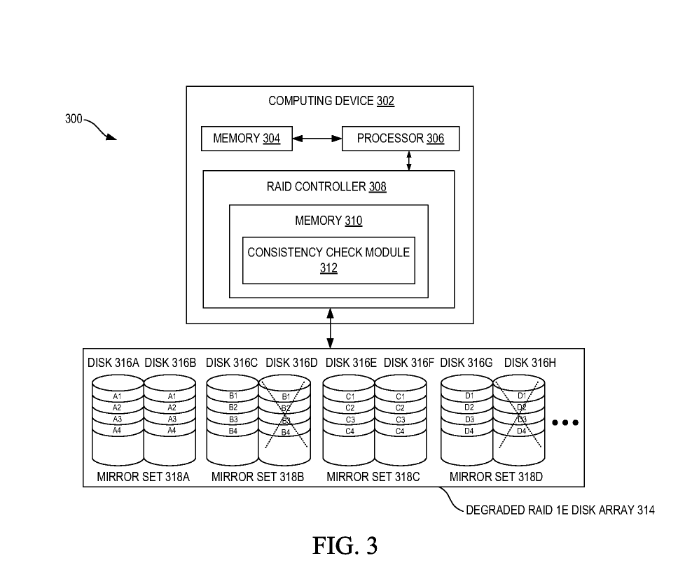

Each of the mirror sets includes a pair of disks. In each of the pair of disks, one disk is the mirror of other disk and is referred to as a mirrored disk. Further, each of the disks in the all the mirror sets in the degraded RAID 1E disk array is divided into a plurality of rows. Each row in a disk forms a block where data is stored (e.g., as shown in FIGS. 2A, 2B and 3). Also, the degraded RAID 1E disk array may be a spanned RAID 1E disk array (e.g., as shown in FIG. 2A) or a non-spanned RAID 1E disk array (e.g., as shown in FIG. 2B).

At step 102, a read request is sent to a first row in all mirror sets having no missing disks. For example, missing disks may be those disks of the mirror sets which are in a failed or offline state in the degraded RAID 1E disk array. At step 104, an exclusive—OR (XOR) operation is performed on the first row in all the mirror sets having no missing disks for determining data consistency between the pair of disks in the mirror set.

At step 106, data on a mirrored disk in all the mirror sets having no missing disks is updated based on the outcome of the performed XOR operation. In one example embodiment, during the XOR operation, if it is found that data is not consistent in a current mirror set, then data on a mirrored disk is updated using other disk in the current mirror set. In another example embodiment, if the data is consistent in the current mirror set, then it is determined to see whether a next mirror set having no missing disks is available in the degraded RAID 1E disk array that requires performing the XOR operation to determine data consistency.

Further, an XOR operation is performed on the next mirror set having no missing disks. If there are no more mirror sets having no missing disks in the first row in the degraded RAID 1E disk array, then the CC operation on the first row is completed. At step 108, the steps of sending, performing and updating is repeated on a next row in the degraded RAID 1E disk array until all the rows in the degraded RAID 1E disk array are completed. It should be noted that, after a read request is sent to a row and a particular disk on the row goes missing before the read request is completely processed, recovery for the missing disk is not performed.

FIG. 2A illustrates an exemplary degraded spanned RAID 1E disk array 200A including 8 mirror sets created using 16 disks, according to one embodiment. As illustrated, the degraded spanned RAID 1E disk array 200A includes 2 spans, each span having 4 mirror sets. The number of spans may extend up to 8 spans in the spanned RAID 1E disk array 200A. In FIG. 2A, the span 1 includes mirror sets 204A-D and the span 2 includes mirror sets 204E-H. Each of the mirror sets 204A-H includes a pair of disks. For example, the mirror set 204A includes disks 202A and 202B, where the disk 202B is a mirrored disk. Each of the disks 202A-P is divided into a plurality of rows (e.g., a first row 206). Further as shown in FIG. 2A, the disk 202D is in a failed or offline state. Hence, in the mirror set 204B, the disk 202D is missing. Similarly, the mirror sets 204D, 204F, and 204H have missing disks in them.

During a CC operation on the degraded spanned RAID 1E disk array 200A, a read request is sent to the first row 206 in the mirror sets 204A, 204C, 204E, and 204G having no missing disks in them. Then, an XOR operation is performed on the first row 206 of the mirror set 204A. In one embodiment, if data in the mirror set 204A is not consistent, then the mirrored disk 202B is updated using data from the disk 202A. In another embodiment, if the data in the mirror set 204A is consistent, then it is determined whether a next mirror set having no missing disk is available in the degraded spanned RAID 1E disk array 200A for performing the XOR operation to determine data consistency.

In the example embodiment illustrated in FIG. 2A, the next available mirror set having no missing disks is the mirror set 204C. The XOR operation is performed on the first row 206 of the mirror set 204C. Similarly, the XOR operation is performed on the mirror sets 204E and 204G. If there are no more mirror sets having no missing disks in the degraded spanned RAID 1E disk array 200A, then the CC operation is completed on the first row 206.

Then, the CC operation on a next row (e.g., a second row) of the mirror sets 204A, 204C, 204E and 204G having no missing disks in the degraded spanned RAID 1E disk array 200A is performed. In one exemplary implementation, a read request is sent to the second row of the mirror sets 204A, 204C, 204E, and 204G. Then, an XOR operation is performed on the second row of the mirror sets 204A, 204C, 204E, and 204G which is similar to the XOR operation performed on the first row 206 as described above. Further, based on the outcome of the performed XOR operation, the mirrored disks may be updated. Likewise, sending the read request, performing the XOR operation, and updating the mirrored disks are repeated until all rows in the degraded spanned RAID 1E disk array 200A are completed.

FIG. 2B illustrates an exemplary degraded non-spanned RAID 1E disk array 200B including 4 mirror sets created using 8 disks, according to one embodiment. The RAID 1E disk array 200B includes mirror sets 2041-L including disks 202Q-X. The mirror sets 204J and 204L have missing disks as the disks 202T and 202X are in a failed or offline state.

During a CC operation on the degraded non-spanned RAID 1E disk array 200B, a read request is sent to the first row 208 in the mirror sets 204I and 204K having no missing disks in them. Then, an XOR operation is performed on the first row 208 of the mirror set 2041. In one embodiment, if data in the mirror set 2041 is not consistent, then the mirrored disk 202R is updated using data from the disk 202Q. In another embodiment, if the data in the mirror set 2041 is consistent, then it is determined whether a next mirror set having no missing disk is available in the degraded non-spanned RAID 1E disk array 200B for performing the XOR operation to determine data consistency.

In the example embodiment illustrated in FIG. 2B, the next available mirror set having no missing disks is the mirror set 204K. The XOR operation is performed on the first row 208 of the mirror set 204K. If there are no more mirror sets having no missing disks in the degraded non-spanned RAID 1E disk array 200B, then the CC operation is completed on the first row 208.

Then, the CC operation on a next row (e.g., a second row) of the mirror sets 2041 and 204K having no missing disks in the degraded non-spanned RAID 1E disk array 200B is performed. For example, a read request is sent to the second row of the mirror sets 204I and 204K. Then, an XOR operation is performed on the second row of the mirror sets 204I and 204K which is similar to the XOR operation performed on the first row 208 as described above. Further, based on the outcome of the performed XOR operation, the mirrored disks may be updated. Likewise, sending the read request, performing the XOR operation, and updating the mirrored disks are repeated until all rows in the degraded non-spanned RAID 1E disk array 200B are completed.

FIG. 3 illustrates an exemplary storage system 300 for implementing embodiments of the present subject matter. As shown, the storage system 300 includes a degraded RAID 1E disk array 314. The RAID 1E disk array 314 is in a degraded state since mirror sets 318B and 318D have missing disks in them. The RAID 1E disk array 314 may be a spanned RAID 1E disk array or a non-spanned RAID 1E disk array. The storage system 300 also includes a computing device 302 including memory 304 and a processor 306.

Further as shown, the computing device 302 includes a RAID controller 308 communicatively coupled to the degraded RAID 1E disk array 314. According to an embodiment of the present subject matter, the RAID controller 308 includes a CC module 312 stored in its memory 310 for performing the CC operation on the degraded RAID 1E disk array 314. For example, the CC module 312 may be stored in the form of instructions in the memory 310 that when executed by the computing device 302, causes the computing device 302 to perform the CC operation as described in FIGS. 1, 2A and 2B. In another embodiment, the CC module 312 may be stored in the form of instructions on a non-transitory computer readable storage medium that when executed by the computing device 302 causes the computing device 302 to perform the CC operation as described in FIGS. 1, 2A and 2B.

In various embodiments, the methods and systems described in FIGS. 1 through 3 enable fixing of inconsistencies in mirror sets having no missing disks in a degraded RAID 1E disk array. The above-described method and systems also avoids sending read requests to mirror sets having missing disks in the degraded RAID 1E disk array.

Although the present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method for performing a consistency check (CC) operation on a degraded RAID 1E disk array, wherein the RAID 1E disk array is formed using a plurality of mirror sets having a plurality of rows and wherein each mirror set includes a pair of disks, comprising:
sending a read request to a first row in all mirror sets having no missing disks;
performing an exclusive—OR (XOR) operation on the first row in all the mirror sets having no missing disks for determining data consistency between the pair of disks in the mirror set; and
updating data on a mirrored disk in all the mirror sets having no missing disks based on the outcome of the performed XOR operation.

2. The method of claim 1, wherein updating the data on the mirrored disk in all the mirror sets having no missing disks based on the outcome of the performed XOR operation comprises:
if data is not consistent in a current mirror set, then updating the data on the mirrored disk in the current mirror set; and
if the data is consistent in the current mirror set, then determining to see whether a next mirror set having no missing disks is available in the degraded RAID 1E disk array that requires performing the XOR operation to determine data consistency.

3. The method of claim 2, further comprising:
if there is a next available mirror set having no missing disks in the first row in the degraded RAID 1E disk array, then performing an XOR operation on the next mirror set having no missing disks;
if there is no mirror set left having no missing disks in the first row in the degraded RAID 1E disk array, then completing the CC operation on the first row.

4. The method of claim 3, further comprising:
repeating the steps of sending, performing and updating on a next row in the degraded RAID 1E disk array until all the rows in the degraded RAID 1E disk array are completed.

5. The method of claim 1, wherein the degraded RAID 1E disk array comprises a spanned RAID 1E disk array or a non-spanned RAID 1E disk array.

6. A non-transitory computer-readable storage medium for performing a CC operation on a degraded RAID 1E disk array having instructions that, when executed by a computing device, cause the computing device to perform a method comprising:
sending a read request to a first row in all mirror sets having no missing disks;
performing an exclusive—OR (XOR) operation on the first row in all the mirror sets having no missing disks for determining data consistency between a pair of disks in the mirror set; and
updating data on a mirrored disk in all the mirror sets having no missing disks based on the outcome of the performed XOR operation.

7. The non-transitory computer-readable storage medium of claim 6, wherein updating the data on the mirrored disk in all the mirror sets having no missing disks based on the outcome of the performed XOR operation comprises:
if data is not consistent in a current mirror set, then updating the data on the mirrored disk in the current mirror set; and
if the data is consistent in the current mirror set, then determining to see whether a next mirror set having no missing disks is available in the degraded RAID 1E disk array that requires performing the XOR operation to determine data consistency.

8. The non-transitory computer-readable storage medium of claim 7, further comprising:
if there is a next available mirror set having no missing disks in the first row in the degraded RAID 1E disk array, then performing an XOR operation on the next mirror set having no missing disks;
if there is no mirror set left having no missing disks in the first row in the degraded RAID 1E disk array, then completing the CC operation on the first row.

9. The non-transitory computer-readable storage medium of claim 8, further comprising:
repeating the steps of sending, performing and updating on a next row in the degraded RAID 1E disk array until all the rows in the degraded RAID 1E disk array are completed.

10. The non-transitory computer-readable storage medium of claim 6, wherein the degraded RAID 1E disk array comprises a spanned RAID 1E disk array or a non-spanned RAID 1E disk array.

11. A storage system, comprising:
a computing device, comprising:
a processor;
a RAID controller communicatively coupled to the processor; and
a degraded RAID 1E disk array communicatively coupled to the RAID controller, wherein the RAID 1E disk array is formed using a plurality of mirror sets having a plurality of rows and wherein each mirror set includes a pair of disks, and wherein the RAID controller comprises a consistency check (CC) module stored in memory of the RAID controller in the form of instructions capable of:
sending a read request to a first row in all mirror sets having no missing disks;
performing an exclusive—OR (XOR) operation on the first row in all the mirror sets having no missing disks for determining data consistency between the pair of disks in the mirror set; and
updating data on a mirrored disk in all the mirror sets having no missing disks based on the outcome of the performed XOR operation.

12. The storage system of claim 11, wherein the CC module has instructions capable of updating the data on the mirrored disk in all the mirror sets having no missing disks based on the outcome of the performed XOR operation comprising:
updating the data on the mirrored disk in the current mirror set if data is not consistent in a current mirror set; and
determining to see whether a next mirror set having no missing disks is available in the degraded RAID 1E disk array that requires performing the XOR operation to determine data consistency, if the data is consistent in the current mirror set.

13. The storage system of claim 12, further comprising the CC module having instructions capable of:
if there is a next available mirror set having no missing disks in the first row in the degraded RAID 1E disk array, then performing an XOR operation on the next mirror set having no missing disks;
if there is no mirror set left having no missing disks in the first row in the degraded RAID 1E disk array, then completing the CC operation on the first row.

14. The storage system of claim 13, further comprising the CC module having instructions capable of:
repeating the steps of sending, performing and updating on a next row in the degraded RAID 1E disk array until all the rows in the degraded RAID 1E disk array are completed.

15. The storage system of claim 11, wherein the degraded RAID 1E disk array comprises a spanned RAID 1E disk array or a non-spanned RAID 1E disk array.
